(19) United States
(12) Patent Application Publication
(10) Pub. No.: US 2025/0083451 A1
(43) Pub. Date: Mar. 13, 2025

(54) DEAERATION DEVICE, DROPLET DISCHARGE DEVICE, DEAERATION PERFORMANCE DETERIORATION DETERMINATION METHOD, AND STORAGE MEDIUM

(71) Applicant: Konica Minolta, Inc., Tokyo (JP)

(72) Inventors: Hiroshi AKITA, Tokyo (JP); Akihiro OKUNO, Tokyo (JP); Hiroshi SHIBATA, Chofu-Tokyo (JP); Eiji TABATA, Osaka (JP)

(21) Appl. No.: 18/882,260

(22) Filed: Sep. 11, 2024

(30) Foreign Application Priority Data
Sep. 12, 2023 (JP) 2023-147306

(51) Int. Cl. B41J 2/19; B01D 19/00

(52) U.S. Cl. CPC B41J 2/19; B01D 19/0031; B01D 19/0063

(57) ABSTRACT

Provided is a deaeration device that includes an external reflux-type deaeration module including a gas permeable membrane capable of removing dissolved gas in liquid, and a hardware processor. The deaeration module includes a first vacuum chamber that communicates with a first end of the gas permeable membrane, a second vacuum chamber that communicates with a second end of the gas permeable membrane, and an atmospheric vent valve that opens or closes an inside of the deaeration module to atmosphere. The hardware processor determines a deterioration in deaeration performance of the deaeration module based on a pressure difference between the first vacuum chamber and the second vacuum chamber when the atmospheric vent valve is closed.

### CROSS-REFERENCE TO RELATED APPLICATIONS

The entire disclosure of Japanese Patent Application No. 2023-147306 filed on Sep. 12, 2023, is incorporated herein by reference in its entirety.

### BACKGROUND OF THE INVENTION

### Technical Field

The present invention relates to a deaeration device, a droplet discharge device, a deaeration performance deterioration determination method, and a storage medium.

### Description of the Related Art

Conventionally, droplet discharge devices that discharge droplets from a droplet discharge section onto a recording surface of a recording medium to record an image have been known. When gas is dissolved in liquid discharged by the droplet discharge device, a problem occurs. Therefore, the droplet discharge device is provided with a deaeration module for deaerating the liquid on a liquid supply path to the droplet discharge section. The deaeration module includes a gas permeable membrane that is in an airtight state and is then depressurized by sucking air therein. Then, when liquid comes into contact with the gas permeable membrane, dissolved gas in the liquid permeates to the gas permeable membrane and is removed.

However, as the deaeration module is used, clogging occurs due to the components that have infiltrated into the gas permeable membrane, and the deaeration performance deteriorates. Therefore, for example, Japanese Unexamined Patent Publication No. 2019-130511 discloses a droplet discharge device that detects whether there is clogging in a gas permeable membrane on the basis of an air pressure difference between a first end and a second end of the gas permeable membrane, and prompts replacement of a deaeration module in a case where there is clogging.

However, the invention of JP2019130511A detects presence or absence of clogging in the gas permeable membrane when the inside of the gas permeable membrane is opened to the atmosphere. That is, since the detection of clogging is performed after the operation of the droplet discharge device is stopped, there is a problem of productivity reduction.

### SUMMARY OF THE INVENTION

The present invention has been made in view of such circumstances. An object of the present invention is to provide a deaeration device, a droplet discharge device, a deaeration performance deterioration determination method, and a storage medium that are capable of determining a deterioration in deaeration performance of a deaeration module without reducing productivity.

To achieve at least one of the abovementioned objects, according to an aspect of the present invention, a deaeration device including:
an external reflux-type deaeration module including a gas permeable membrane capable of removing dissolved gas in liquid; and
a hardware processor,
wherein the deaeration module includes a first vacuum chamber that communicates with a first end of the gas permeable membrane, a second vacuum chamber that communicates with a second end of the gas permeable membrane, and an atmospheric vent valve that opens or closes an inside of the deaeration module to atmosphere,
wherein the hardware processor determines a deterioration in deaeration performance of the deaeration module based on a pressure difference between the first vacuum chamber and the second vacuum chamber when the atmospheric vent valve is closed.

To achieve at least one of the abovementioned objects, according to another aspect of the present invention, a droplet discharge device including:
a droplet discharge section that discharges droplets; and
the deaeration device described above.

To achieve at least one of the abovementioned objects, according to an aspect of the present invention, a deaeration performance deterioration determination method of a deaeration device,
wherein the deaeration device includes:
   an external reflux-type deaeration module including a gas permeable membrane capable of removing dissolved gas in liquid, wherein the deaeration module includes a first vacuum chamber that communicates with a first end of the gas permeable membrane, a second vacuum chamber that communicates with a second end of the gas permeable membrane, and an atmospheric vent valve that opens or closes an inside of the deaeration module to atmosphere,
wherein the deaeration performance deterioration determination method includes:
   measuring a pressure deference between the first vacuum chamber and the second vacuum chamber when the deaeration module is atmospherically closed; and
   determining a deterioration in deaeration performance of the deaeration module based on the pressure difference.

To achieve at least one of the abovementioned objects, according to another aspect of the present invention, a computer-readable storage medium storing a program for a computer of a deaeration device,
wherein the deaeration device includes:
   an external reflux-type deaeration module including a gas permeable membrane capable of removing dissolved gas in liquid,
wherein the deaeration module includes a first vacuum chamber that communicates with a first end of the gas permeable membrane, a second vacuum chamber that communicates with a second end of the gas permeable membrane, and an atmospheric vent valve that opens or closes an inside of the deaeration module to atmosphere,
wherein the program causes the computer of the deaeration device to function as:
   a controller that determines a deterioration in deaeration performance of the deaeration module based on the pressure difference when the atmospheric vent valve is closed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a cross-sectional side view of an inkjet recording apparatus;

FIG. 2 is a schematic configuration diagram of a liquid delivery section;

FIG. 3 is a cross-sectional side view of a deaeration module;

FIG. 4 is a block diagram of the inkjet recording apparatus;

FIG. 5 is a flowchart of deaeration performance deterioration determination processing according to the first embodiment;

FIG. 6 is a graph in which the ink flow rate and the pressure difference are plotted for each degree of use of the deaeration device;

FIG. 7 is a flowchart of the deaeration performance deterioration determination processing according to the second embodiment; and

FIG. 8 is a flowchart of the deaeration performance deterioration determination processing according to the third embodiment.

### DETAILED DESCRIPTION

Hereinafter, a droplet discharge device according to an embodiment of the present invention will be described in detail with reference to the drawings. However, the scope of the present invention is not limited to the disclosed embodiments. In the following description, components having the same functions and configurations are denoted by the same reference numerals, and the description thereof will be omitted.

### [Overall Configuration of Inkjet Recording Apparatus]

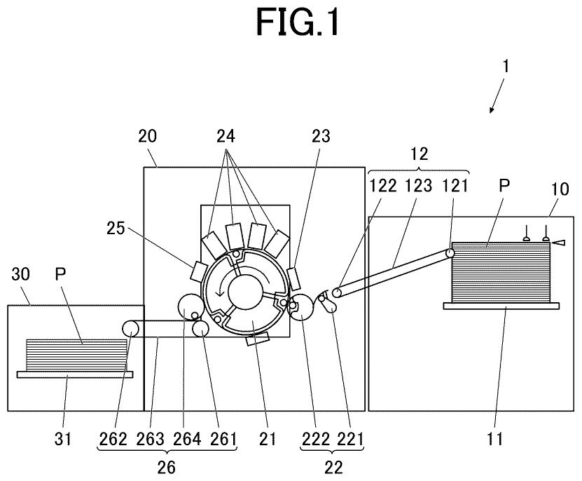

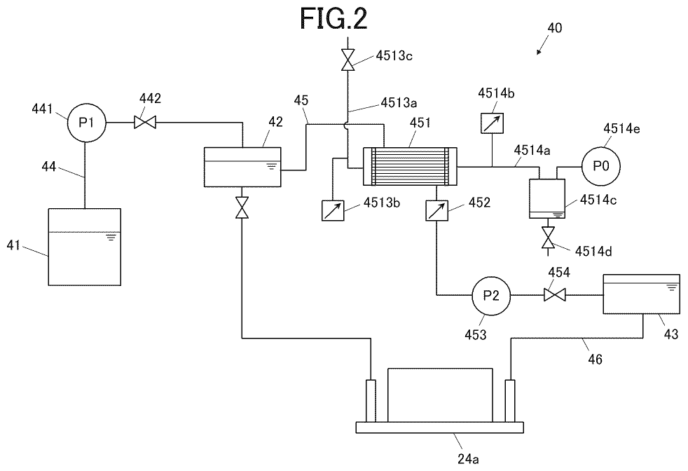

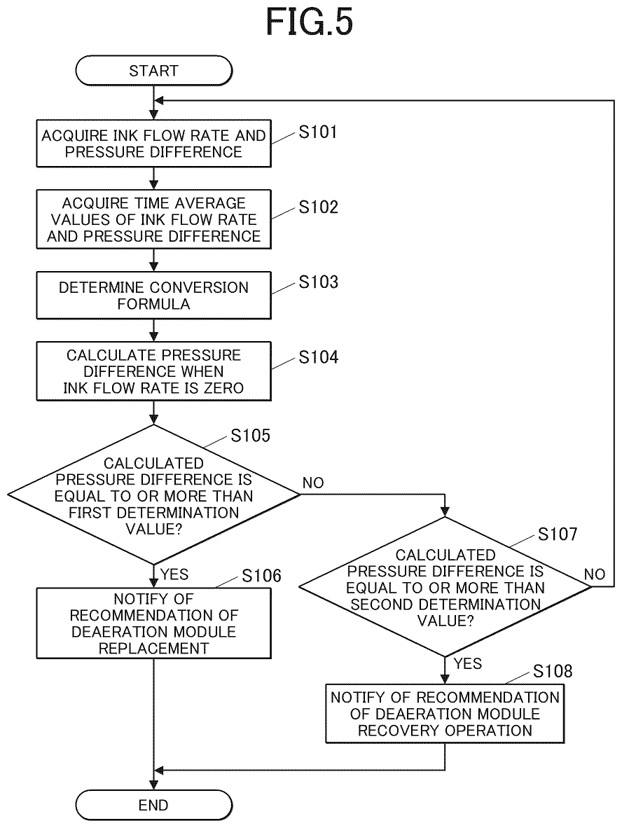

First, a droplet discharge device including a deaeration module will be described with reference to FIG. 1. FIG. 1 is a side cross-sectional view illustrating a main configuration of an inkjet recording apparatus 1 which is an embodiment of a droplet discharge device including a deaeration module 451 (see FIG. 2). The inkjet recording apparatus 1 includes a sheet feed section 10, an image forming section 20, a sheet ejection section 30, a liquid delivery section 40 (see FIG. 2), a controller 50 (hardware processor) (see FIG. 4), and a notifying section 60 (see FIG. 4). The liquid delivery section 40 and the controller 50 constitute a deaeration device 100 (see FIG. 4).

The inkjet recording apparatus 1 conveys a recording medium P from the sheet feed section 10 to the image forming section 20 based on the control of the controller 50. Then, the controller 50 causes the image forming section 20 to form an image on the recording medium P with the ink supplied from the liquid delivery section 40. After image formation, the controller 50 ejects the recording medium P to the sheet ejection section 30.

### (Sheet Feed Section)

The sheet feed section 10 stores recording media P before image formation. The sheet feed section 10 conveys the recording media P to the image forming section 20 under the control of the controller 50. The sheet feed section 10 includes a sheet feed tray 11 and a conveyance section 12.

### {Sheet Feed Tray}

The sheet feed tray 11 is a plate member that stores the recording media P. The sheet feed tray 11 is provided such that one or more recording media P can be placed thereon. The sheet feed tray 11 moves up and down according to the amount of the recording media P placed thereon. The sheet feed tray 11 is held at a position where the uppermost recording medium P is conveyed by the conveyance section 12 in the vertical movement direction.

### {Conveyance Section}

The conveyance section 12 conveys the recording medium P from the sheet feed tray 11 to the image forming section 20. The conveyance section 12 includes a conveyance mechanism. The conveyance mechanism drives the belt 123 to convey the recording medium P on the belt 123. The belt 123 has a loop shape. The inside of the loop of belt 123 is supported by a plurality of rollers 121, 122. The conveyance section 12 delivers the uppermost recording medium P placed on the sheet feed tray 11 onto the belt 123, and conveys the recording medium P along the belt 123.

### (Image Forming Section)

The image forming section 20 records an image on the recording medium P in cooperation with the liquid delivery section 40 under the control of the controller 50. The image forming section 20 includes an image forming drum 21, a handover unit 22, a sheet heating section 23, head units 24, an irradiation section 25, and a delivery section 26.

### {Image Forming Drum}

The image forming drum 21 carries the recording medium P along its cylindrical outer peripheral surface. The image forming drum 21 conveys the recording medium P by rotating in a conveyance direction. The conveyance surface of the image forming drum 21 faces the sheet heating section 23, the head units 24, and the irradiation section 25. The image forming section 20 performs image forming processing on the recording medium P conveyed by the image forming drum 21.

### {Handover Unit}

The handover unit 22 is provided at a position interposed between the conveyance section 12 and the image forming drum 21. The handover unit 22 includes a claw 221 and a handover drum 222.

The claw 221 is a cylindrical member that holds one end of the recording medium P conveyed by the conveyance section 12. The handover drum 222 is a member that guides the recording medium P supported by the claw 221.

The handover unit 22 picks up the recording medium P on the conveyance section 12 with the claw 221 and places the recording medium P along the outer peripheral surface of the handover drum 222. The handover unit 22 hands over the recording medium P to the image forming drum 21 by the above-described operation.

### {Sheet Heating Section}

The sheet heating section 23 includes, for example, a heating wire and generates heat in response to energization. The sheet heating section 23 is controlled by the controller 50 to generate heat so that the recording medium P passing through the vicinity thereof reaches a predetermined temperature. The sheet heating section 23 is provided in the vicinity of the outer circumferential surface of the image forming drum 21 and on the upstream side of the head units 24 in the conveyance direction of the recording medium P.

A temperature sensor (not illustrated) is provided in the vicinity of the sheet heating section 23. The controller 50 detects the temperature in the vicinity of the sheet heating section 23 with the temperature sensor. The controller 50 controls heat generation of the sheet heating section 23 based on the detected temperature.

### {Head Units}

The head units 24 function as a droplet discharge section to discharge ink droplets from nozzles onto a recording medium P to form an image. The head units 24 are provided respectively corresponding to colors of C (cyan), M (magenta), Y (yellow), and K (black). In FIG. 1, the head units 24 corresponding to the respective colors of Y, M, C, and K are provided in order from the upstream with respect to the conveyance direction of the recording medium P.

Here, a direction perpendicular to the conveyance direction of the recording medium P in plan view is defined as a width direction. A plurality of the head units 24 of the present embodiment are provided so as to be arranged with a length (width) that covers the entire recording medium P in the width direction. That is, the inkjet recording apparatus 1 is a one-pass line-head type inkjet recording apparatus. Each of the head units 24 includes an array of inkjet heads 24a (see FIG. 2), which are droplet discharge heads. The number of the head units 24 may be five or more or three or less. Alternatively, a single inkjet head 24a may constitute the head units 24 here.

The ink discharged by the head units 24 is, for example, ultraviolet curable ink (UV ink). The ultraviolet curable ink is a gel-like ink that undergoes a phase change between a gel state and a liquid (sol) state according to the temperature when ultraviolet rays are not irradiated from the irradiation section 25. The ultraviolet curable ink has a phase change temperature of, for example, about 40 to 100° C., and is uniformly liquefied (solated) by being heated to the phase change temperature or higher. On the other hand, the ultraviolet curable ink is gelled at about normal room temperature, that is, about 0 to 30° C.

### {Irradiation Section}

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided in the vicinity of the outer peripheral surface of the image forming drum 21. The irradiation section 25 is provided so as to be located on the downstream side of the head units 24 in the conveyance direction of the recording medium P. The irradiation section 25 irradiates with energy rays the recording medium P on which ink has been ejected. The ink on the recording medium P is cured by the action of the energy rays.

Note that the fluorescent tube that emits ultraviolet rays is not limited to the low-pressure mercury lamp. The fluorescent tube may be a mercury lamp with operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet light with higher illuminance. The fluorescent tube is, for example, a light emitting diode or the like. The energy ray is not limited to the ultraviolet ray, and may be an energy ray having a property of curing the ink in accordance with the property of the ink. Then, the light source is also replaced in accordance with the energy rays.

In the above description, the case where the head units 24 discharge the ultraviolet curable ink is described, but the invention is not limited thereto. The ink discharged by the head units 24 may be water-based ink or ink having other physical properties.

### {Delivery Section}

The delivery section 26 includes a conveyance mechanism. The conveyance mechanism conveys the recording medium P by driving a ring-shaped belt 263 whose inner side is supported by a plurality of rollers 261 and 262. The delivery section 26 includes a cylindrical handover roller 264. The handover roller 264 hands over the recording medium P from the image forming drum 21 to the conveyance mechanism. The delivery section 26 conveys the recording medium P handed over onto the belt 263 by the handover roller 264 and sends it to the sheet ejection section 30.

### (Sheet Ejector)

The recording medium P on which an image has been formed by the image forming section 20 is ejected to the sheet ejection section 30. The sheet ejection section 30 includes a sheet ejection tray 31 having a plate shape. The recording medium P sent from the image forming section 20 by the delivery section 26 is placed on the sheet ejection tray 31. The sheet ejection section 30 stores the recording medium P until a user takes out the recording medium P.

### (Liquid Delivery Section)

FIG. 2 shows a schematic configuration diagram of the liquid delivery section 40. The liquid delivery section 40 includes a plurality of main tanks 41 that store the respective colors of ink. The liquid delivery section 40 supplies the respective color inks in the main tanks 41 to the respective head units 24. The liquid delivery section 40 renders the ink of each color dischargeable from a nozzle by the control.

As illustrated in FIG. 2, the liquid delivery section 40 includes a main tank 41, a first sub tank(s) 42, and a second sub tank(s) 43, which are liquid storage sections. The liquid delivery section 40 also includes a deaeration module 451 that removes dissolved gas in ink before delivery to the head units 24.

### <Main Tank>

The main tank 41 is a tank that stores ink to be supplied to each part of the liquid delivery section 40. The main tank 41 is, for example, a rigid sealed tank made of metal. The main tank 41 communicates with the first sub tank 42 via a supply pipe 44. The supply pipe 44 is provided with a supply pump 441 and a supply valve 442.

### <Supply Pump, Supply Valve>

The supply pump 441 and the supply valve 442 operate under the control of the controller 50. The ink in the main tank 41 is supplied to the first sub tank 42 via the supply pipe 44 by driving of the supply pump 441 when the supply valve 442 is opened. The entire main tank 41 is replaceable. Further, the main tank 41 can be attached to and detached from the supply pipe 44 regardless of the driving state of the supply pump 441.

### <First Sub Tank>

The first sub tank 42 is one or a plurality of ink chambers having a smaller volume than the main tank 41. The ink pumped out of the main tank 41 by the supply pump 441 is stored in the first sub tank 42. By providing the first sub tank 42, pressure fluctuation due to pulsation when the supply pump 441 supplies the ink in the main tank 41 is alleviated. Ink that has not been discharged from the inkjet heads 24a is collected to the first sub tank 42 from the outlet. The first sub tank 42 communicates with the second sub tank 43 via a liquid feed pipe 45. The liquid feed pipe 45 is provided with the deaeration module 451, a liquid flow rate sensor 452, a liquid feed pump 453, a liquid feed valve 454, and the like. Details of the deaeration module 451 will be described later.

### <Liquid Flow Rate Sensor>

The liquid flow rate sensor 452 is provided in the vicinity of the deaeration module 451 on the liquid feed pipe 45. The liquid flow rate sensor 452 detects the flow rate of the ink flowing through the liquid feed pipe 45 and sends the flow rate to the controller 50. In addition, a configuration in which the liquid flow rate sensor 452 is provided on the downstream side of the deaeration module 451 is illustrated in FIG. 2, but the invention is not limited thereto. The liquid flow rate sensor 452 may be provided on the upstream side of the deaeration module 451.

### <Liquid Feed Pump>

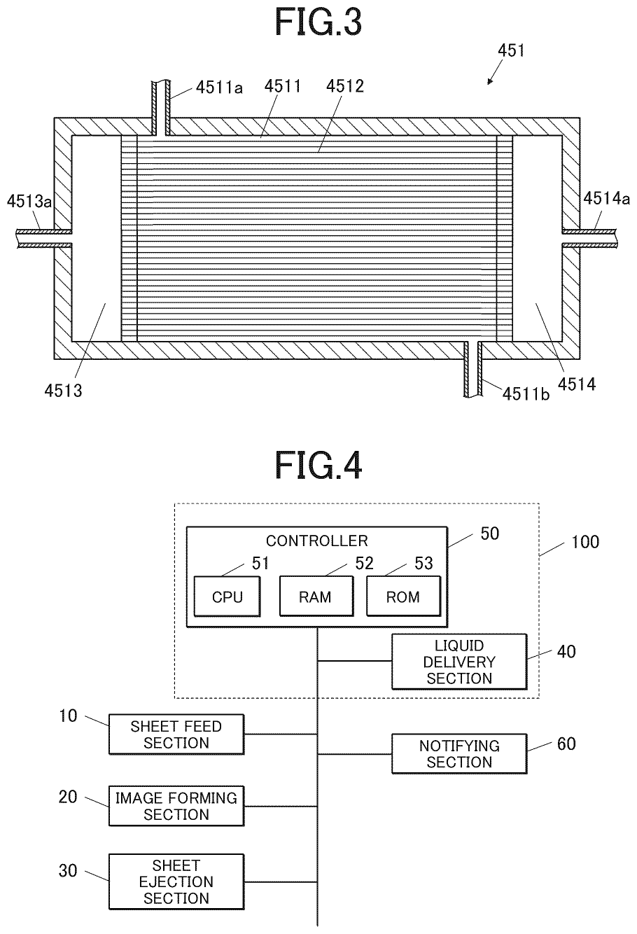

The liquid feed pump 453 feeds, to the second sub tank 43, the ink that has flown out of the ink outlet 4511b (see FIG. 3) of the deaeration module 451. A check valve (not illustrated) is provided between the liquid feed pump 453 and the second sub tank 43 to prevent backflow of the ink sent to the second sub tank 43.

### <Liquid Feed Valve>

The liquid feed valve 454 is an electromagnetic valve, and selectively opens and closes the liquid feed pipe 45 during operation of the liquid feed pump 453 under the control of the controller 50.

### <Second Sub Tank>

The second sub tank 43 is a small tank chamber in which the ink deaerated by the deaeration module 451 is temporarily stored. The capacity of the second sub tank 43 is, for example, substantially the same as that of the first sub tank 42. The second sub tank 43 is in communication with the inlet of each of the inkjet heads 24a via a supply path 46. The ink in the second sub tank 43 is supplied to each of the inkjet heads 24a according to the amount of ink to be discharged from the nozzles. Further, the second sub tank 43 is provided with a back pressure adjusting means (not illustrated) for preventing the ink from leaking out by applying an appropriate negative pressure to the inkjet heads 24a.

### <Deaeration Module>

FIG. 3 shows the deaeration module 451. The deaeration module 451 removes dissolved gas in the ink that has flowed thereinto, and discharges the deaerated ink. The deaeration module 451 includes an ink circulation chamber 4511, a gas permeable membrane 4512, a first vacuum chamber 4513, a second vacuum chamber 4514, and the like.

### {Ink Circulation Chamber}

The ink circulation chamber 4511 is provided in a central portion of the inside of the casing forming the deaeration module 451. The ink circulation chamber 4511 is provided with an ink inlet 4511a and receives inflow of ink from the first sub tank 42. In addition, the ink circulation chamber 4511 is provided with an ink outlet 4511b, and sends the ink out to the second sub tank 43.

Note that as illustrated in FIG. 3, the ink inlet 4511a and the ink outlet 4511b are preferably provided on a first end side and a second end side opposite to the first end side of the ink circulation chamber 4511, respectively. In particular, as illustrated in FIG. 3, it is more preferable that the ink inlet 4511a and the ink outlet 4511b are provided on a substantially diagonal line of the ink circulation chamber 4511. According to the above-described configuration, the ink comes into contact with the gas permeable membrane 4512 more easily, and the deaeration efficiency of the deaeration module 451 can be increased.

### {Gas Permeable Membrane}

The gas permeable membrane 4512 has a tubular shape, and its membrane surface has gas permeability. The gas permeable membrane 4512 is, for example, a hollow fiber membrane. The gas permeable membrane 4512 has a large number of hollow fine thread structures, and the threads are arranged in a bundle so as to extend in the axial direction of the ink circulation chamber 4511.

In addition, as illustrated in FIG. 3, the gas permeable membrane 4512 is disposed so as to allow the first vacuum chamber 4513 and the second vacuum chamber 4514 to communicate with each other. Therefore, the first end of the gas permeable membrane 4512 is connected to the atmosphere via an atmospheric vent valve 4513c (described later). In addition, the second end of the gas permeable membrane 4512 is connected to a vacuum pump 4514e (described later).

### {First Vacuum Chamber}

The first vacuum chamber 4513 is provided at the first end of the deaeration module 451. The first vacuum chamber 4513 is formed so as to be partitioned from the ink circulation chamber 4511 by a partition wall. The side of the first vacuum chamber 4513 facing the ink circulation chamber 4511 is connected to the atmosphere via a first vacuum path 4513a. As illustrated in FIG. 2, the first vacuum path 4513a is provided with a first pressure sensor 4513b, an atmospheric vent valve 4513c, and the like.

The first pressure sensor 4513b detects a pressure value in the first vacuum chamber 4513 and sends the pressure value to the controller 50. The atmospheric vent valve 4513c is an electromagnetic valve. The atmospheric vent valve 4513c opens or closes the inside of the first vacuum path 4513a to the atmosphere according to the control signal of the controller 50.

### {Second Vacuum Chamber}

The second vacuum chamber 4514 is provided on the second end side of the deaeration module 451 facing the first vacuum chamber 4513. The second vacuum chamber 4514 is formed so as to be partitioned from the ink circulation chamber 4511 by a partition wall. The second vacuum chamber 4514 communicates with a depressurizing tank 4514c via a second vacuum path 4514a. As illustrated in FIG. 2, the second vacuum path 4514a is provided with a second vacuum sensor 4514b for detecting a pressure value of its inside.

The second pressure sensor 4514b detects a pressure value in the second vacuum chamber 4514 and sends the pressure value to the controller 50. As described later, the controller 50 controls driving of the deaeration module 451 in accordance with, for example, the pressure values acquired from the first and second pressure sensors 4513b and 4514b. Note that although FIG. 2 illustrates the case where the second pressure sensor 4514b is provided in a channel between the deaeration module 451 and the depressurizing tank 4514c, it is not limited thereto. The second pressure sensor 4514b may be provided in a channel between the depressurizing tank 4514c and the vacuum pump 4514e (described later).

The depressurizing tank 4514c includes an ink ejection valve 4514d and the vacuum pump 4514e. The depressurizing tank 4514c is capable of storing a predetermined volume of gas, and suppresses a variation in pressure in the gas permeable membrane 4512 due to pulsation of the vacuum pump 4514e. Furthermore, the depressurizing tank 4514c stores therein the ink that has infiltrated into the gas permeable membrane 4512 and has entered the second vacuum path 4514a. Since the ink is stored in the depressurizing tank 4514c, it is possible to prevent the ink from reaching the vacuum pump 4514e to break down the vacuum pump 4514e. The ink is ejected to the outside by the ink ejection valve 4514d.

The vacuum pump 4514e is a diaphragm pump. Specifically, the vacuum pump 4514e includes a pump chamber having an extendable diaphragm. Furthermore, the vacuum pumping 4514e includes a drive source or the like that operates the diaphragm such that the volume of the pump chamber expands and contracts. The pump chamber includes a suction port having a check valve that allows only inflow of a fluid from the outside. The pump chamber also includes a discharge port having a check valve that allows only outflow of a fluid from the inside of the pump chamber.

When the atmospheric vent valve 4513c is closed, the vacuum pump 4514e sucks the air in the gas permeable membrane 4512 under the control of the controller 50. By this operation of the vacuum pump 4514e, foreign substances are removed from the inside of the gas permeable membrane 4512, and the pressure is reduced. Therefore, when the ink having flown into the ink circulation chamber 4511 comes into contact with the membrane surface of the gas permeable membrane 4512, the dissolved gas selectively permeates the membrane surface and is removed. Then, the dissolved gas that has passed through the gas permeable membrane 4512 flows down to the depressurizing tank 4514c via the second vacuum chamber 4514c.

In the present invention, the external reflux type deaeration module 451 configured as described above is adopted. Although the form of the deaeration module 451 is not limited, it is preferable to use a sheet in which a plurality of gas permeable membranes 4512 are woven into a mesh shape, for example. With this structure, the meshes of the gas permeable membranes 4512 become finer, and all of the ink easily passes through the meshes of the gas permeable membrane 4512. Therefore, deaeration efficiency increases. Furthermore, with the above-described configuration, even a flexible gas permeable membrane 4512 is likely to have a certain strength or more.

### (Controller)

FIG. 4 is a block diagram illustrating an internal configuration of the inkjet recording apparatus 1. The controller 50 controls each section constituting the inkjet recording apparatus 1. As shown in FIG. 4, the controller 50 is connected to each section constituting the inkjet recording apparatus 1. The controller 50 includes a central processing unit (CPU) 51, a random access memory (RAM) 52, a read only memory (ROM) 53, and the like.

The CPU51 reads various programs and date corresponding to processing contents from the storage device of the ROM 53 or the like and executes them. In addition, the CPU 51 controls the operation of each section of the inkjet recording apparatus 1 according to the contents of the executed processing. The RAM 52 temporarily stores therein the various programs and date processed by the CPU 51. The ROM 53 stores the various programs and date read by the CPU 51 or the like.

### (Notifying Section)

The notifying section 60 provides notification of various types of information under the control of the controller 50. The notifying section 60 is, for example, a display part having a screen or a communication section capable of communicating with other devices via a network.

### Deaeration Performance Deterioration Determination Processing (First Embodiment)

Deaeration performance deterioration determination processing of the deaeration module 451 in the inkjet recording apparatus 1 will be described with reference to the flowchart of FIG. 5. In this processing, the controller 50 determines whether or not the deaeration performance of the deaeration module 451 has deteriorated. In addition, all of the deaeration performance deterioration determination processing according to the following first to third embodiments is executed in a state where the atmospheric vent valve 4513c is closed.

First, the controller 50 acquires the flow rate of the ink in the deaeration module 451 and the difference between the pressures of the first and second pressure sensors 4513b and 4514b for a predetermined time (for example, three minutes) (Step S101).

The flow rate of the ink in the deaeration module 451 can be acquired on the basis of, for example, data measured by the liquid flow rate sensor 452. The liquid flow rate sensor 452 requires a space for installation, and it is necessary to adopt a sensor having heat resistance and ink resistance. Therefore, a configuration may be adopted in which the liquid flow rate sensor 452 is not provided and the controller 50 acquires the flow rate of the ink in the deaeration module 451 from the data of the consumption amount of the ink. The data of the ink consumption amount can be calculated from, for example, image data used for image formation.

After measuring the flow rate of the ink and the pressure difference, the controller 50 calculates the time averages of the ink flow rate and the pressure difference by dividing the measured ink flow rate and the pressure difference by the measurement time (Step S102).

The controller 50 determines a conversion formula for the ink flow rate and the pressure difference (Step S103).

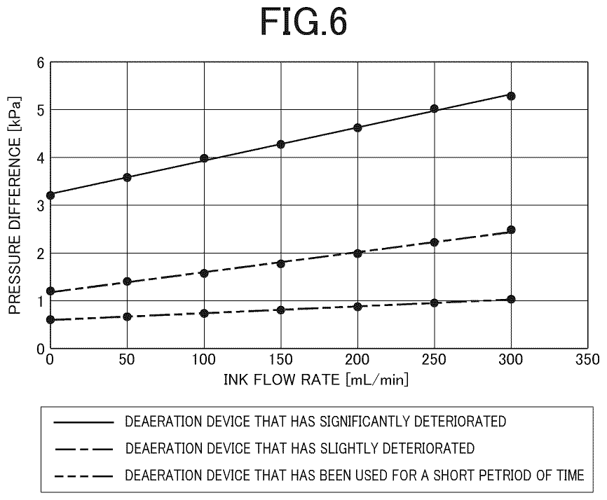

FIG. 6 is a graph in which the relationship between the ink flow rate and the pressure difference is plotted for each degree of use of the deaeration device 100. In FIG. 6, the horizontal axis represents ink flow rate, and the vertical axis represents pressure difference. As shown in FIG. 6, the ink flow rate and the pressure difference show a linear relationship represented by a linear function.

As illustrated in FIG. 6, even when the deaeration device 100 has the same degree of use, the pressure difference increases as the ink flow rate increases. The reason for this is as follows. The gas flowing through the gas permeable membrane 4512 is mainly composed of the dissolved gas in the ink taken into the gas permeable membrane 4512 and the gas flowing from the atmospheric vent valve 4513c. However, when the ink flow rate increases, the ratio of the dissolved gas in the ink increases, and the ratio of the gas flowing from the atmospheric vent valve 4513c decreases. Then, even if the suction operation is performed by the vacuum pump 4514e, the degree of vacuum of the second vacuum chamber 4514 does not increase, and the pressure difference from the first vacuum chamber 4513 increases.

In addition, as shown in FIG. 6, the deaeration device 100 (deaeration module 451) deteriorates as the degree of use progresses, and the pressure difference increases even at the same ink flow rate. Specifically, as the deaeration device 100 is degraded, the slope and the intercept of the line increase. This is because when clogging occurs in the gas permeable membrane 4512 and the deaeration performance of the deaeration module 451 deteriorates, the resistance to the air flowing through the gas permeable membrane 4512 increases, and the pressure difference increases.

Influential factors such as the ink flow rate and the degree of use of the deaeration device 100 have a relatively large effect on the pressure difference when the atmospheric vent valve 4513c is closed and the air flow rate is low. Therefore, it is possible to accurately determine whether or not the deaeration performance of the deaeration module 451 has deteriorated by correction so as to remove the influence of the influential factors from the pressure difference.

Specifically, first, the controller 50 selects a temporary conversion formula (the slope of the conversion formula) from, for example, Formulae (1) to (3) in accordance with the time of use of the deaeration device 100. Here, the time during which the power supply of the inkjet recording apparatus 1 is in the ON state is used as the time of use of the deaeration device 100.

$$y = 0.0014 x + Y 1 ( time of use : 0 hours to 480 hours ) \qquad ( 1 )$$

$$y = 0.0042 x + Y 2 ( time of use : 480 hours to 1920 hours ) \qquad ( 2 )$$

$$y = 0.07 x + Y 3 ( use time : 1920 hours or more ) \qquad ( 3 )$$

$$( x : time average value of ink flow rate ( ml / min ) , y : time average value of value pressure difference ( kpa / min ) )$$

The controller 50 also calculates the value of the intercept (any of Y1 to Y3) by substituting the time average values of the ink flow rate and the pressure difference calculated in Step 102 into the selected temporary conversion formula. The conversion formula is thereby determined.

The controller 50 calculates, from the determined conversion formula, the pressure difference when the flow rate is zero (Step S104).

Step S103 and Step S104 will be described with reference to specific examples. For example, when the time of use of the inkjet recording apparatus 1 is 600 hours, Formula (2) is selected as the temporary conversion expression. It is assumed that the calculated time average value of the ink flow rate is 100 ml/min and the time average value of the pressure difference is 2. 5 kPa/min. When these values are substituted into Formula (2), from 2.5=0.0042×100+Y2, Y2=2.08 is obtained, and the conversion formula is y=0.0042×+2.08. In addition, when the ink flow rate is zero, the pressure difference is y=2.08 kPa by substituting x=0.

The controller 50 determines whether the difference between the pressure difference calculated in Step S104 is equal to or greater than the first determination value (Step S105). When the difference is equal to or greater than the first determination value (Yes in Step S105), the controller 50 causes the notifying section 60 to send a notification to replace the deaeration module 451 (Step S106).

When the pressure difference calculated in Step S104 is smaller than the first determination value (Step S105; No), the controller 50 determines whether the calculated pressure difference is equal to or greater than the second determination value which is smaller than the first determination value (Step S107). When the pressure difference is equal to or greater than the second determination value (Step S107; Yes), the controller 50 causes the notifying section 60 to send a notification to perform a recovery operation of the deaeration module 451 (Step S108). After the notification for replacement or recovery of the deaeration module 451 by the notifying section 60, the controller 50 ends the deaeration performance deterioration determination processing.

When the pressure difference calculated in Step S104 is smaller than the second determination value (Step S107; No), the controller 50 transitions to Step S101. That is, after a predetermined time, the controller 50 acquires the ink flow rate and the pressure difference again, and continues the deaeration performance reduction determination processing.

For example, in the present embodiment, the first determination value is 3. 0 kPa, and the second determination value is 1. 0 kPa. Therefore, since 1. 0 kPa<y=2.08 kPa<3. 0 kPa, the controller 50 causes the notifying section 60 to send a notification to perform a recovery operation of the deaeration module 451.

The recovery operation of the deaeration module 451 is, for example, as described above, an operation of causing the vacuum pumps 4514 to perform the suction operation when the atmospheric vent valve 4513c is opened. Alternatively, a user may connects a pressure source such as a compressor to the first vacuum path 4513a and pressurize the inside of the gas permeable membrane 4512. Through these operations, the foreign substances in the gas permeable membrane 4512 are removed, and the deaeration performance of the deaeration module 451 is recovered.

### Effects of First Embodiment

In a case where the atmospheric vent valve 4513c is opened to determine a deterioration in the deaeration performance of the deaeration module 451, it is necessary to stop the deaeration processing of the deaeration device 100, and productivity is reduced by the determination processing more and more each time. However, as described above, the deaeration device 100 according to the present embodiment determines a decrease in the deaeration performance of the deaeration module 451 in a state where the atmospheric vent valve 4513c is closed. Therefore, it is possible to determine a deterioration in the deaeration performance of the deaeration module 451 without decreasing productivity.

Furthermore, the deaeration device 100 according to the present embodiment determines deterioration in the deaeration performance of the deaeration module 451 on the basis of the pressure difference between the first vacuum chamber 4513 and the second vacuum chamber 4514 and influential factors affecting the pressure difference, specifically, the ink flow rate and the degree of use of the deaeration device 100. Therefore, even when the atmospheric vent valve 4513c is closed, deterioration in the deaeration performance can be more accurately determined.

In the present embodiment, the liquid to be deaerated by the deaeration device 100 is UV ink. Usually, the ink components of the UV ink easily enter the gas permeable membrane 4512, and the deaeration performance of the deaeration module 451 tends to deteriorate. However, according to the deaeration performance deterioration determination processing according to the present embodiment, it is possible to appropriately and accurately determine deterioration in the deaeration performance of the deaeration module 451.

### Deaeration Performance Deterioration Determination Processing (Second Embodiment)

In the above description, the ink flow rate and the pressure difference in the deaeration module 451 are acquired, the ink flow rate is changed to zero, and whether or not the deaeration module 451 is clogged from the pressure difference at that time is determined, but the invention is not limited thereto. In the deaeration performance deterioration determination processing according to the second embodiment, a determination value serving as a reference for determining whether or not the deaeration module 451 is clogged is corrected. Then, by comparing with the pressure difference at a predetermined ink flow rate, whether or not the deaeration module 451 is clogged is determined.

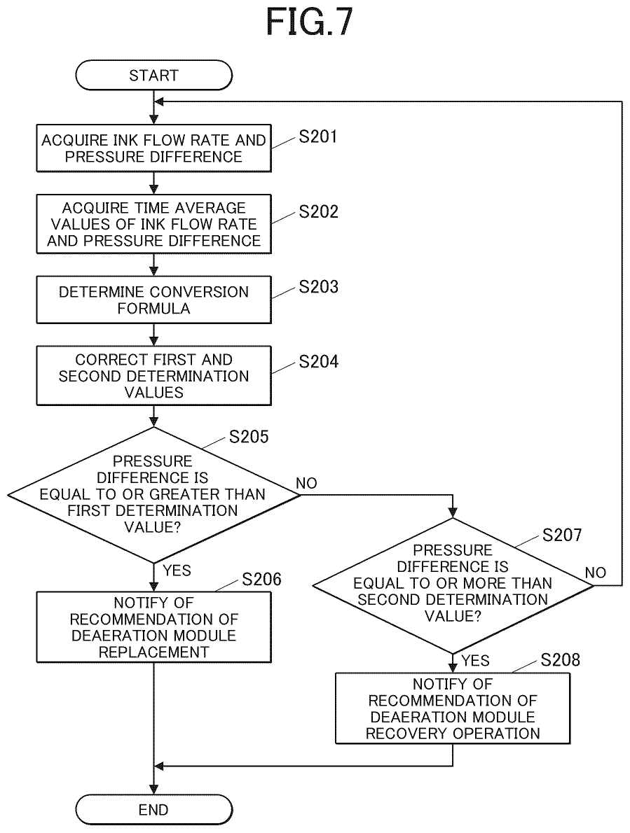

The deaeration performance deterioration determination processing according to the second embodiment will be described with reference to the flowchart of FIG. 7. Note that in the following description, detailed description of substantially the same contents as those in the flowchart of FIG. 5 will be omitted.

Steps S201 to S203 are substantially the same as Steps S101 to S103. In addition, similarly to the above description, it is assumed that the time of use of the inkjet recording apparatus 1 is 600 hours, the time average value of the ink flow rate is 100 ml/min, and the time average value of the pressure difference is 2.5 kPa/min. Therefore, the conversion formula is determined to be y=0.0042×+2.08 in Step S203. Further, it is assumed that the first determination value=3.0 and the second determination value=1.0.

The controller 50 calculates a correction amount for the first determination value and the second determination value from the conversion formula, and corrects the first determination value and the second determination value (Step S204). Specifically, the correction amount is calculated by multiplying the slope of the determined conversion formula by the calculated time average value of the ink flow rate. Next, the calculated correction amounts are added to the first determination value and the second determination value, respectively, to correct the determination values.

To be more specific, the correction amount in the present embodiment is 0.0042×100=0.42. Then, the first determination value is corrected to 3.0+0.42=3.42 (kPa), and the second determination value is corrected to 1.0+0.42=1.42 (kPa).

Subsequent Steps S205 and S208 are substantially the same as Steps S105 and S108 in FIG. 5. That is, the controller 50 compares the acquired time average of the pressure difference with the corrected determination value, and causes the notifying section 60 to send a notification of warning or continues the deaeration performance deterioration determination processing again, according to the result.

In the present embodiment, since 1.42<2.5<3.42, the controller 50 causes the notifying section 60 to send a notification of warning to perform the recovery operation of the deaeration module 451.

### Effects of Second Embodiment

The deaeration device 100 according to the second embodiment corrects the determination values in accordance with the influential factor and compares the corrected determination value with the pressure difference to determine deterioration in the deaeration performance of the deaeration module 451. Also in the above-described configuration, deterioration in the deaeration performance can be more accurately determined.

### Deaeration Performance Deterioration Determination Processing (Third Embodiment)

In the first and second embodiments whether or not the deaeration module 451 is clogged is determined depending on whether or not the pressure difference at the predetermined ink flow rate exceeds the determination value. However, there are individual differences in the configuration constituting the deaeration device 100 or the inkjet recording apparatus 1 in which the deaeration device 100 is mounted. Therefore, even if the inkjet recording apparatuses 1 having the same degree of use and the same configuration have the same ink flow rate, the value of the pressure difference may vary depending on the individual differences. Therefore, even if the pressure difference or the determination value is corrected, it may not be possible to accurately determine whether or not the deaeration performance of the deaeration module 451 has deteriorated.

Therefore, in the third embodiment, the pressure difference at a predetermined ink flow rate in the initial state of the deaeration module 451 is acquired. Then, the deterioration of the deaeration performance of the deaeration module 451 is determined by comparing the determination value based on the pressure difference with the corrected pressure difference.

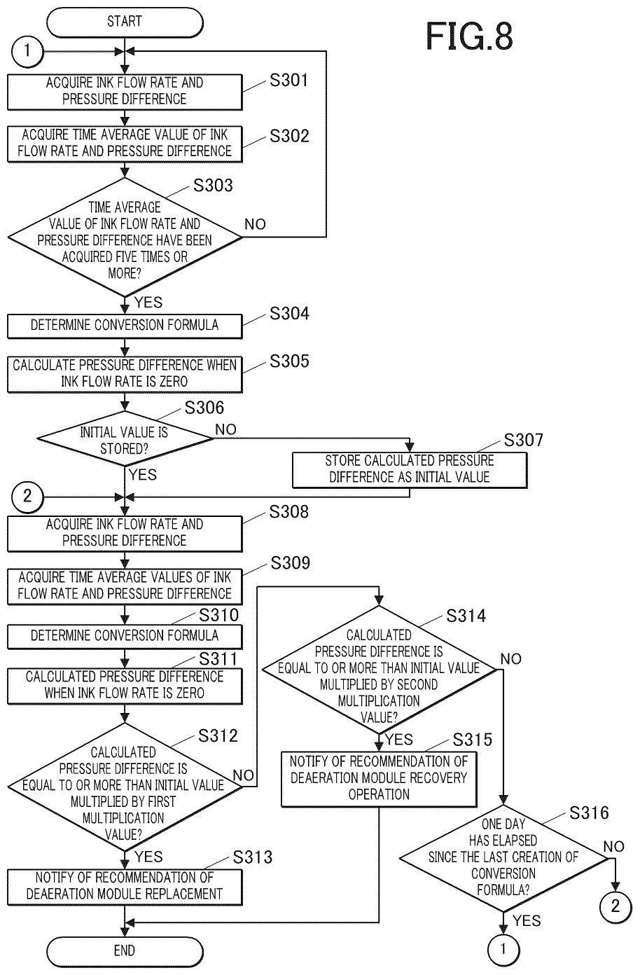

The deaeration performance reduction determination processing in the above-described configuration will be described with reference to the flowchart of FIG. 8. Note that in the following description, detailed description of substantially the same contents as those in the flowchart of FIG. 5 will be omitted.

Steps S301 and S302 are substantially the same as Steps S101 and S102. After the calculation of the time average values of the ink flow rate and the pressure difference, the controller 50 determines whether or not time average values of the ink flow rate and the pressure difference have been acquired a predetermined number of times in the deaeration performance deterioration determination processing. In the present embodiment, determined is whether or not the time average values of the ink flow rate and the pressure difference have been obtained, for example, five times or more (Step S303). In detail, in Step S304 to be described later, in order to obtain a conversion formula of the ink flow rate and the pressure difference by regression calculation, determined is whether or not data pairs of the time average values of the ink flow rate and the pressure difference of five different levels are acquired. In a case where the number of times of acquisition of the time average values of the ink flow rate and the pressure difference is less than five times (Step S303; No), the controller 50 transitions to Step S301 and acquires time average values of the ink flow rate and the pressure difference of different levels.

When the time average values of the ink flow rate and the pressure difference are obtained five times or more (Step S303; Yes), the controller 50 determines a conversion formula for the ink flow rate and the pressure difference by regression calculation on the obtained five data pairs of different levels (Step S304). Further, the controller 50 calculates the pressure difference when the ink flow rate is zero from the conversion formula (Step S305).

The controller 50 determines whether or not the initial value, which is the pressure difference when the flow rate of ink in the initial state is zero, is stored in ROM 53 (Step S306). When the initial value is not stored (Step S306; No), the controller 50 stores the difference as the initial value (Step S307).

When the initial value is stored in the ROM 53 (Step S306; Yes), or after the pressure difference is stored as the initial value, Steps S308 to S311 are the same as Steps S101 to S104. That is, the ink flow rate and the pressure difference are obtained, and the time average values are calculated from the ink flow rate and the pressure difference. Next, only the intercept of the conversion formula is updated from the calculated time average values, and the pressure difference when the ink flow rate is zero is calculated from the conversion formula.

The controller 50 determines whether the calculated pressure difference is equal to or greater than the initial value multiplied by the first multiplication value (for example, the first multiplication value is 5) (Step S312).In a case where the calculated pressure difference is equal to or greater than the initial value multiplied by the first multiplication value (Step S312; Yes), the controller 50 causes the notifying section 60 to send a notification to recommend replacement of the deaeration module 451 (Step S313).

In a case where the calculated pressure difference is less than the initial value multiplied by the first multiplication value (Step S312; No), the controller 50 determines whether or not the calculated pressure difference is equal to or greater than the initial value multiplied by the second multiplication value (for example, the second multiplication value is 2) which is smaller than the first multiplication value (Step S314). In a case where the pressure difference is equal to or greater than the initial value multiplied by the second multiplication value (Step S314; Yes), the controller 50 causes the notifying section 60 to send a notification of warning to execute the recovery operation of the deaeration module 451 (Step S315). After the notification of the replacement or the recovery operation of the deaeration module 451 by the notifying section 60, the controller 50 ends the deaeration performance deterioration determination processing.

In a case where the calculated pressure difference is less than the second magnification (Step S314; No), the controller 50 determines whether or not one day or more has elapsed since the previous determination of the conversion formula (Step S316).

In a case where one day or more has elapsed (Step S316; Yes), the controller 50 transitions to Step S301 and updates the slope and the intercept of the conversion formula. When one day or more has not elapsed since the conversion formula was determined last time (Step S316; No), the controller 50 transitions to S308, updates only the intercept of the conversion formula, and continues the deaeration capability deterioration determination processing.

### Effects of Third Embodiment

As described above, in the present embodiment, deterioration of the deaeration performance of the deaeration module 451 is determined by comparing the correction value of the pressure difference with the determination value based on the pressure difference acquired in the initial state of the inkjet recording apparatus 1. According to the above-described configuration, a deterioration in the deaeration performance of the deaeration module 451 is determined on the basis of influential factors such as an individual difference of the deaeration system 100 or the inkjet recording apparatus 1.

Therefore, deterioration in the deaeration performance can be more accurately determined.

### Variations

Although specific description has been given above based on the embodiment according to the present invention, the present invention is not limited to the above-described embodiment. It is a matter of course that the present invention can be subjected to various modifications within the scope of the invention described in the claims and the equivalents thereof.

For example, in the above description, in a case where deterioration in the deaeration performance is determined when the atmospheric vent valve 4513c is closed, a correction corresponding to an influential factor is performed, but the present invention is not limited thereto. Even in a case where the deterioration of the deaeration performance is determined when the atmospheric vent valve 4513c is opened, that is, when the flow rate of the air is large and the influence of the influential factor on the pressure difference is small, it is possible to perform more accurate determination by a correction according to the influential factor.

In the above description, the pressure difference or the determination value is corrected on the basis of the conversion formula, but the present invention is not limited thereto. For example, a conversion table may be stored in the ROM 53 in advance and correction is performed based on the conversion table.

In the above description, Formulae (1) to (3) are shown as examples of the temporary conversion formulae. However, the number of the temporary conversion formulae is not limited to three, and may be more or less than three. Further, the temporary conversion formula is a linear function formula in the above description, but the present invention is not limited thereto. The temporary conversion formulae are not limited to the formulae (1) to (3), and may be appropriately and arbitrarily determined according to the specifications of the deaeration device 100 and the inkjet recording apparatus 1, the results of the tests, and the like.

Furthermore, although the inkjet recording apparatus 1 that discharges ink has been given as an example of one embodiment of the droplet discharge device in the description above, it is not limited thereto. That is, the liquid deaerated by the deaeration device 100 according to the present invention is not limited to ink, but may be, for example, a pretreatment agent, blood, or water. In addition, the deaeration device 100 is not limited to the configuration provided with the droplet discharge device.

In the above description, an example in which a hard disk, a semiconductor non-volatile memory, or the like is used as a computer-readable medium for the program according to the present invention has been disclosed, but the medium is not limited to this example. As another computer-readable medium, a portable recording medium such as a CD-ROM can be applied. Furthermore, a carrier wave is also applied as a medium for providing data of the program according to the present invention via a communication line.

1. A deaeration device comprising:
an external reflux-type deaeration module including a gas permeable membrane capable of removing dissolved gas in liquid; and
a hardware processor,
wherein the deaeration module includes a first vacuum chamber that communicates with a first end of the gas permeable membrane, a second vacuum chamber that communicates with a second end of the gas permeable membrane, and an atmospheric vent valve that opens or closes an inside of the deaeration module to atmosphere,
wherein the hardware processor determines a deterioration in deaeration performance of the deaeration module based on a pressure difference between the first vacuum chamber and the second vacuum chamber when the atmospheric vent valve is closed.

2. The deaeration device according to claim 1,
wherein the hardware processor determines the deterioration in the deaeration performance of the deaeration module based on the pressure difference and an influential factor that affects the pressure difference.

3. The deaeration device according to claim 2,
wherein the influential factor is any one or more of a liquid flow rate, a degree of use of the deaeration device, an individual difference of the deaeration device, and an individual difference of an apparatus on which the deaeration device is mounted.

4. The deaeration device according to claim 3,
wherein the hardware processor acquires the liquid flow rate from a liquid flow rate sensor provided in a vicinity of the deaeration module.

5. The deaeration device according to claim 3,
wherein the hardware processor acquires the liquid flow rate based on a consumption amount of the liquid.

6. The deaeration device according to claim 2,
wherein the hardware processor corrects the pressure difference according to the influential factor, and compares the corrected pressure difference with a determination value to determine the deterioration in the deaeration performance of the deaeration module.

7. The deaeration device according to claim 2,
wherein the hardware processor corrects a determination value in accordance with the influential factor, and compares the pressure difference with the corrected determination value to determine the deterioration in the deaeration performance of the deaeration module.

8. The deaeration device according to claim 6,
wherein the determination value is based on the pressure difference in an initial state of the deaeration device.

9. The deaeration device according to claim 6,
wherein the hardware processor has a plurality of levels of the determination value.

10. The deaeration device according to claim 6,
wherein the hardware processor performs correction by a conversion formula created on a basis of a relationship between the liquid flow rate and the pressure difference.

11. The deaeration device according to claim 10,
wherein the conversion formula is a linear function.

12. The deaeration device according to claim 10,
wherein the conversion formula used by the hardware processor is different according to the degree of use of the deaeration device.

13. The deaeration device according to claim 1, further comprising:
a notifying section that outputs a message corresponding to a determination result of the hardware processor.

14. The deaeration device according to claim 8,
wherein the conversion formula used by the hardware processor is unique for each deaeration device.

15. The deaeration device according to claim 1,
wherein the deaeration module removes dissolved gas in UV ink.

16. A droplet discharge device comprising:
a droplet discharge section that discharges droplets; and
the deaeration device according to claim 1.

17. A deaeration performance deterioration determination method of a deaeration device,
wherein the deaeration device comprises:
an external reflux-type deaeration module including a gas permeable membrane capable of removing dissolved gas in liquid,
wherein the deaeration module includes a first vacuum chamber that communicates with a first end of the gas permeable membrane, a second vacuum chamber that communicates with a second end of the gas permeable membrane, and an atmospheric vent valve that opens or closes an inside of the deaeration module to atmosphere,
wherein the deaeration performance deterioration determination method comprises:
measuring a pressure deference between the first vacuum chamber and the second vacuum chamber when the deaeration module is atmospherically closed; and
determining a deterioration in deaeration performance of the deaeration module based on the pressure difference.

18. The deaeration performance deterioration determination method according to claim 17, further comprising:
determining the deterioration in the deaeration performance of the deaeration module based on the pressure difference and an influential factor that affects the pressure difference.

19. A computer-readable storage medium storing a program for a computer of a deaeration device,
wherein the deaeration device comprises:
an external reflux-type deaeration module including a gas permeable membrane capable of removing dissolved gas in liquid,
wherein the deaeration module includes a first vacuum chamber that communicates with a first end of the gas permeable membrane, a second vacuum chamber that communicates with a second end of the gas permeable membrane, and an atmospheric vent valve that opens or closes an inside of the deaeration module to atmosphere,
wherein the program causes the computer of the deaeration device to function as:
a controller that determines a deterioration in deaeration performance of the deaeration module based on the pressure difference when the atmospheric vent valve is closed.
